(19) United States
(12) Patent Application Publication
(10) Pub. No.: US 2024/0147099 A1
(43) Pub. Date: May 2, 2024

(54) SENSOR DEVICE

(71) Applicant: SONY GROUP CORPORATION, TOKYO (JP)

(72) Inventor: MASAKI SAKAKIBARA, TOKYO (JP)

(21) Appl. No.: 18/548,591

(22) PCT Filed: Feb. 15, 2022
(86) PCT No.: PCT/JP2022/005985

§ 371 Date: Sep. 1, 2023

(30) Foreign Application Priority Data
Mar. 9, 2021 (JP) 2021-037142

(51) Int. Cl. H04N 25/773; H04N 25/443; H04N 25/47

(52) U.S. Cl. CPC H04N 25/773; H04N 25/443; H04N 25/47

(57) ABSTRACT

A sensor device according to the present technology includes an SPAD element, a detection unit that detects a photon reception reaction by the SPAD element to output a pulse indicating the photon reception reaction, and, in response to the pulse output, resets a state of own to a state in which a photon reception reaction is detectable, and a pulse count unit that counts the number of the pulses output by the detection unit.

### TECHNICAL FIELD

The present technology relates to a sensor device, and particularly relates to sensing technology for implementing a spike camera imitating a photosensitive characteristic of human eyes.

### BACKGROUND ART

For example, the following Non-Patent Documents 1 and 2 disclose a technique of forming an image by calculating a signal of a spike train imitating a photosensitive characteristic of human eyes. For human eyes, a signal called a spike train is obtained in response to light reception. This spike train is obtained as a signal in which an interval of spikes changes according to intensity of received light, and specifically, the interval of the spikes is narrowed in a case where the intensity of the received light is high.

### CITATION LIST

### Non-Patent Documents

Non-Patent Document 1: Lin Zhu, et. al, “Retina-like Visual Image Reconstruction via Spiking Neural Model”, CVPR2020
Non-Patent Document 2: Lin Zhu, et. al, “A retina-inspired sampling method for visual texture reconstruction” In 2019 IEEE
International Conference on Multimedia and Expo (ICME), pages 1432-1437, 2019.1, 2, 7

### SUMMARY OF THE INVENTION

### Problems to be Solved by the Invention

Here, it is considered to implement a camera device imitating a photosensitive characteristic of human eyes, in other words, a camera device that detects luminance by generating a spike train according to intensity of received light similarly to human eyes (hereinafter, referred to as a “spike camera”).

In Non-Patent Documents 1 and 2 described above, a method for calculating a signal of a spike train according to light reception is disclosed, but a specific hardware configuration for achieving the method is not disclosed.

The present technology has been made in view of the circumstances described above, and an object thereof is to implement a spike camera imitating a photosensitive characteristic of human eyes.

### Solutions to Problems

A sensor device according to the present technology includes an SPAD element, a detection unit that detects a photon reception reaction by the SPAD element to output a pulse indicating the photon reception reaction, and, in response to the pulse output, resets a state of own to a state in which a photon reception reaction is detectable, and a pulse count unit that counts the number of the pulses output by the detection unit.

With a configuration in which the detection unit performs the above-described reset, a spike train can be appropriately obtained even in a high illuminance state, and the number of spikes (the number of pulses) in the spike train can be appropriately counted by the above-described pulse count unit.

The above-described sensor device according to the present technology can have a configuration in which a plurality of pixels including the SPAD element, the detection unit, and the pulse count unit is two-dimensionally arranged.

This makes it possible to implement a spike camera capable of acquiring a two-dimensional captured image.

The above-described sensor device according to the present technology can have a configuration in which the pixel includes a calculation unit that performs calculation for obtaining an output value of an own pixel on the basis of a detection result of the photon reception reaction, by the detection unit in the own pixel, and detection results of photon reception reactions, by the detection units in a predetermined number of other pixels including at least another pixel adjacent to the own pixel.

By obtaining the output value of the own pixel in consideration of not only the photon reception reaction of the own pixel but also at least the photon reception reaction of the adjacent another pixel, it is possible to reproduce a role of a horizontal cell in a human eye.

The above-described sensor device according to the present technology can have a configuration in which the calculation unit cause the pulse count unit to execute count of the pulses on condition that the detection unit in the own pixel and the detection units in the predetermined number of other pixels detect the photon reception reactions.

As described above, by executing a pulse counting of the own pixel on condition that not only the own pixel but also the predetermined number of other pixels in vicinity including the another pixel adjacent to the own pixel detect photon reception reactions, it is possible to reproduce a role of a horizontal cell in a human eye.

The above-described sensor device according to the present technology can have a configuration in which the calculation unit determines, by using an AND gate circuit, whether or not the condition is satisfied.

This makes it possible to appropriately perform the condition determination by using a digital logic circuit.

The above-described sensor device according to the present technology can have a configuration in which the calculation unit reflects a count value of the pulses output by the detection unit in each of the predetermined number of other pixels to the count value of the pulses output by the detection unit in an own pixel.

As described above, by reflecting the pulse count values of the predetermined number of other pixels in vicinity including the another pixel adjacent to the pulse count value of the own pixel in this manner, it is possible to reproduce a role of a horizontal cell in a human eye.

The above-described sensor device according to the present technology can have a configuration in which the predetermined number of other pixels are selected by a kernel.

This makes it possible to variably set, by using the kernel, which pixels are to be used as the other pixels that affect the output value of the own pixel.

The above-described sensor device according to the present technology can have a configuration in which the pulse count unit outputs a signal in a case where the number of counts of the pulses is equal to or greater than a threshold value.

This makes it possible to output a value indicating whether or not a luminance is equal to or more than a certain level as the output value of the pixel.

The above-described sensor device according to the present technology can have a configuration in which the pulse count unit counts the number of the pulses with a digital counter.

This makes it possible to appropriately perform the pulse count by using a digital logic circuit.

The above-described sensor device according to the present technology can have a configuration in which the pulse count unit counts the number of the pulses with an analog counter.

By using the analog counter, the number of pulses can be counted with a simple configuration.

The above-described sensor device according to the present technology can have a configuration in which the analog counter includes a counter using a capacitor in which a charged amount changes according to the pulse output by the detection unit.

By using a counter using the capacitor as described above, pulse count can be achieved with a simple configuration.

The above-described sensor device according to the present technology can have a configuration in which a row control circuit that executes reading of output values of the pixels for each pixel row is further included.

With this arrangement, the output values of the pixels are read by a scanning method.

The above-described sensor device according to the present technology can have a configuration in which the output values of the pixels are read with an arbiter method.

By adopting the arbiter method, it is possible to quickly read the values of the pixels having undergone a photon reception reaction in a predetermined manner.

### BRIEF DESCRIPTION OF DRAWINGS

FIG. 1 is a block diagram illustrating an internal configuration example of a sensor device as a first embodiment according to the present technology.

FIG. 2 is a diagram for describing an overview of an internal configuration of a pixel included in the sensor device as the first embodiment.

FIG. 3 is a diagram exemplifying a characteristic of a spike train.

FIG. 4 is a diagram exemplifying a circuit configuration of a spike output unit included in the sensor device as the first embodiment.

FIG. 5 is a diagram for describing an internal configuration example of a calculation unit, a count unit, and an output unit included in the sensor device as the first embodiment.

FIG. 6 is a diagram for describing a configuration of a pixel as a first example of a second embodiment.

FIG. 7 is a diagram for describing a configuration of a pixel as a second example of the second embodiment.

FIG. 8 is a block diagram illustrating an internal configuration example of a sensor device as a third embodiment.

FIG. 9 is a diagram for describing a configuration of a pixel included in the sensor device as the third embodiment.

FIG. 10 is a diagram illustrating an internal configuration example of an AER logic circuit illustrated in FIG. 9.

FIG. 11 is a diagram exemplifying a circuit configuration of a spike output unit as a modification.

FIG. 12 is an explanatory diagram of an example of a kernel.

FIG. 13 is an explanatory diagram of an example of calculation based on a coefficient of the kernel illustrated in FIG. 11.

FIG. 14 is an explanatory diagram of a configuration example in a case where pixel selection by a kernel is implemented with an analog method.

FIG. 15 is an explanatory diagram of another example of an analog counter.

### MODES FOR CARRYING OUT THE INVENTION

Hereinafter, embodiments will be described in the following order.
<1. First Embodiment>
(1-1. Overall configuration of sensor device)
(1-2. Overview of configuration of pixel)
(1-3. Configuration of spike output unit)
(1-4. Configurations of calculation unit, count unit, and output unit)
<2. Second Embodiment>
<3. Third Embodiment>
<4. Modification examples>
<5. Summary of embodiments>
<6. Present technology>

### 1. First Embodiment

(1-1. Overall Configuration of Sensor Device)

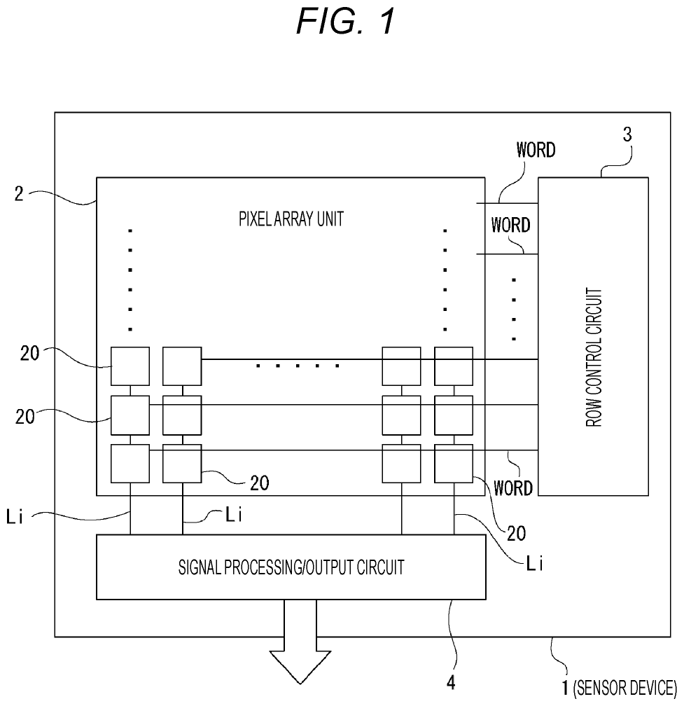

FIG. 1 is a block diagram illustrating an internal configuration example of a sensor device 1 as a first embodiment according to the present technology.

As illustrated in the drawing, the sensor device 1 includes a pixel array unit 2, a row control circuit 3, and a signal processing/output circuit 4.

The pixel array unit 2 has a configuration in which a plurality of pixels 20 is two-dimensionally arranged in a matrix in a row direction and a column direction. Here, the row direction refers to a pixel arrangement direction in a horizontal direction, and the column direction refers to a pixel arrangement direction in a vertical direction. In the drawing, the row direction is a lateral direction, and the column direction is a longitudinal direction.

Each pixel 20 includes a photoelectric conversion element (photodetector) that performs photoelectric conversion. Specifically, in the sensor device 1 of the present example, each pixel 20 includes a single photon avalanche diode (SPAD) element (SPAD element 21 to be described later) as the photodetector.

In the pixel array unit 2, with respect to the pixel arrangement in the matrix, row control lines WORD are wired along the row direction for respective pixel rows, and vertical signal lines Li are wired along the column direction for respective pixel columns.

A row control line WORD transmits a word signal for driving when reading a signal from the pixel 20. One end of each row control line WORD is connected to an output end corresponding to each row of the row control circuit 3.

The row control circuit 3 includes, for example, a timing generator that generates various timing signals, a shift register, an address decoder, and the like, drives the pixels 20 by outputting the word signals through the row control lines WORD, and controls reading of signals from the pixels 20. Specifically, the row control circuit 3 in the present example causes the signals to be read from the pixels 20 row by row, sequentially.

The vertical signal lines Li are wiring lines for transmitting the signals read from the pixels 20 to the signal processing/output circuit 4, and one end of each of the vertical signal lines Li is connected to an output end corresponding to each column of the signal processing/output circuit 4.

The signal processing/output circuit 4 acquires the signals read from the pixels 20 through the vertical signal lines Li, performs predetermined signal processing, and outputs the signals.

(1-2. Overview of Configuration of Pixel)

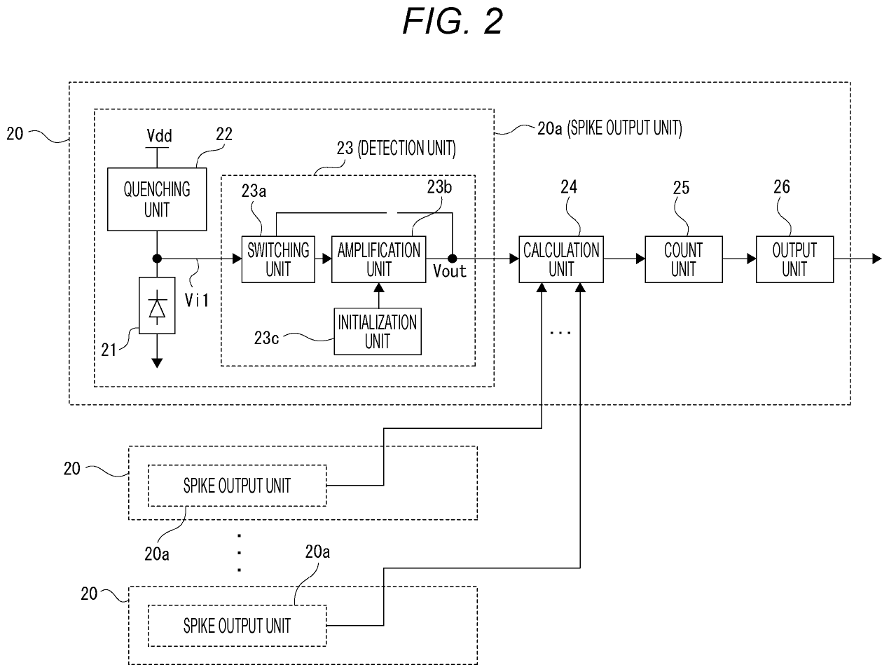

FIG. 2 is a diagram for describing an overview of an internal configuration of a pixel 20.

As illustrated in FIG. 2, the pixel 20 includes a spike output unit 20a, a calculation unit 24, a count unit 25, and an output unit 26.

The spike output unit 20a includes the SPAD element 21 and is configured to output spikes at intervals corresponding to intensity of received light.

Here, an object of the present embodiment is to implement a spike camera imitating a photosensitive characteristic of human eyes. As described above, for human eyes, a signal called a spike train is obtained in response to light reception. This spike train is obtained as a signal in which an interval of spikes changes according to intensity of received light.

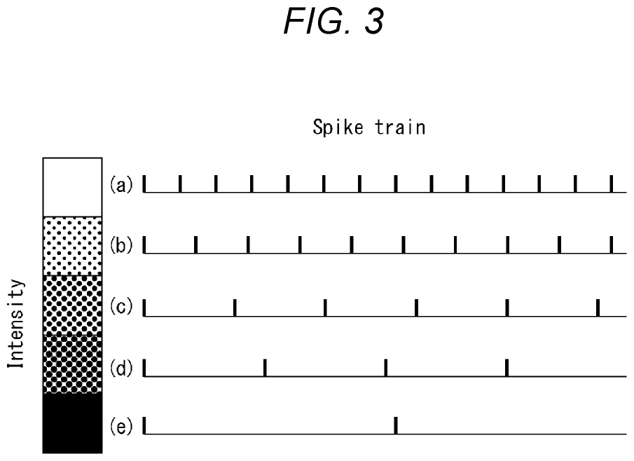

FIG. 3 exemplifies a characteristic of a spike train.

As illustrated in the drawing, in the spike train, the stronger the intensity of the received light, the narrower the interval between the spikes.

The description is returned to FIG. 2.

The spike output unit 20a includes a quenching unit 22 and a detection unit 23 together with the SPAD element 21.

In the spike output unit 20a, when photons are incident on the SPAD element 21, an avalanche breakdown occurs, and a voltage of a signal line Vi1 changes. In the quenching unit 22, because a voltage drop according to a current occurs, a voltage between terminals of the SPAD element 21 decreases to a breakdown voltage, and the avalanche breakdown stops.

The detection unit 23 includes a switching unit 23a, an amplification unit 23b, and an initialization unit 23c, and is configured to detect a photon reception reaction by the SPAD element 21 as the above-described avalanche breakdown, output a pulse indicating the photon reception reaction, and, in response to the pulse output, reset a state of own to a state in which a photon reception reaction is detectable.

The switching unit 23a performs switching between detection operation of detecting a photon reception reaction in the SPAD element 21 and a reset operation of resetting an internal state of own.

The amplification unit 23b amplifies a detection signal obtained by the switching unit 23a when the photon reception reaction in the SPAD element 21 is detected, and outputs the amplified detection signal as an output voltage Vout. The output voltage Vout is output as a pulse voltage.

The initialization unit 23c changes a voltage level in the detection unit 23 at a time of the above-described reset operation so that the detection unit 23 can detect a photon reception reaction again.

The calculation unit 24 performs calculation for obtaining an output value of an own pixel on the basis of a detection result of a photon reception reaction by the detection unit 23 in the own pixel and detection results of photon reception reactions by detection units 23 in a predetermined number of other pixels including at least another pixel adjacent to the own pixel.

Specifically, the calculation unit 24 in the present example is configured to cause the count unit 25 to execute count of pulses on condition that the detection unit 23 in the own pixel and the detection units 23 in the above-described predetermined number of other pixels detect photon reception reactions.

Here, by obtaining the output value of the own pixel in consideration of not only the photon reception reaction of the own pixel but also at least the photon reception reaction of the adjacent another pixel, it is possible to reproduce a role of a horizontal cell in a human eye.

The count unit 25 counts the number of pulses output by the detection unit 23. In the present example, because the above-described calculation unit 24 is provided, the count unit 25 counts the pulses output by the detection unit 23 in the own pixel on condition that the detection unit 23 in the own pixel and the detection units 23 in the above-described predetermined number of other pixels detect photon reception reactions.

The output unit 26 outputs the output value of the count unit 25 as an output value of the pixel 20.

(1-3. Configuration of Spike Output Unit)

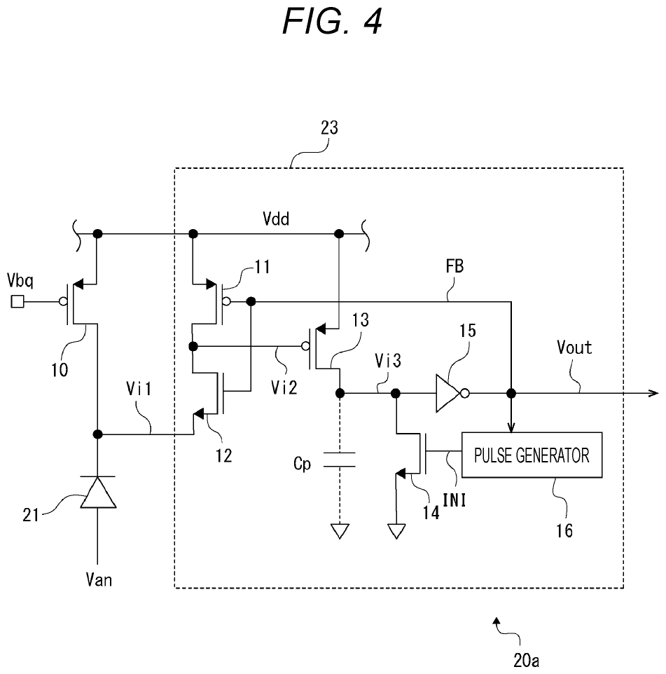

FIG. 4 is a circuit diagram exemplifying a circuit configuration of the spike output unit 20a.

In the drawing, a transistor 10 including a P-MOS transistor is an example of the quenching unit 22 illustrated in FIG. 2. Note that, it is only required that an element corresponding to a load element with respect to the SPAD element 21 is used as a constituent element of the quenching unit 22, and a resistor may be disposed instead of the transistor 10.

Furthermore, in the spike output unit 20a, as illustrated in the drawing, the detection unit 23 includes a transistor 11, a transistor 12, a transistor 13, a transistor 14, an inverter 15, and a pulse generator 16. The transistor 11 and the transistor 13 are P-MOS transistors, and the transistor 12 and the transistor 14 are N-MOS transistors.

Sources of the transistor 10, the transistor 11, and the transistor 13 are connected to a power supply voltage Vdd. Meanwhile, a drain of the transistor 10 is connected to a cathode of the SPAD element 21. Furthermore, the cathode of the SPAD element 21 is connected to a source of the transistor 12 via the signal line Vi1. A voltage Van is applied to an anode of the SPAD element 21. A value of the voltage Van can be determined so that a reverse voltage equal to or higher than the breakdown voltage is applied between the cathode and anode (between terminals) of the SPAD element 21. A drain of the transistor 12 is connected to a drain of the transistor 11 and a gate of the transistor 13. A signal line Vi2 connects a connection point between the drains of the transistor 11 and transistor 12, and the gate of the transistor 13.

A drain of the transistor 13 is connected to an input terminal of the inverter 15 and a drain of the transistor 14 via a signal line Vi3. An output line of the output voltage Vout is connected to an output terminal of the inverter 15. Furthermore, the output terminal of the inverter 15 is also connected to an input terminal of the pulse generator 16. Moreover, the output terminal of the inverter 15 is also connected to a gate of the transistor 11 and a gate of the transistor 12 via a signal line FB. Meanwhile, a gate of the transistor 14 is connected to an output terminal of the pulse generator 16 via a signal line INI. A source of the transistor 14 is connected to a ground (GND) potential. As the ground potential, for example, a reference potential of the spike output unit 20a, a reference potential of a signal line, and a grounding potential can be used. However, any type of potential may be used as the ground potential. Note that a parasitic capacitance Cp between the signal line Vi3 and the ground potential is illustrated in the drawing.

Here, sources of the transistor 10, transistor 11, and transistor 13 may be connected to the power supply voltage Vdd in common. Furthermore, at least any one of the sources of the transistor 10, transistor 11, and transistor 13 may be connected to different power supply voltages.

Operation of the spike output unit 20a according to the above-described configuration will be described.

When the SPAD element 21 reacts with photons, and current between the cathode and anode of the SPAD element 21 increases, voltage of the signal line Vi1 decreases according to a voltage drop between the source and drain of the transistor 10. Therefore, a voltage of the signal line Vi2 connected to the signal line Vi1 via the transistor 12 changes from HIGH to LOW. When a LOW voltage is applied to the gate of the transistor 13, a source-drain channel of the transistor 13 is closed, and a voltage of the signal line Vi3 is raised to HIGH by the power supply voltage Vdd. The inverter 15 to which a HIGH signal is input from the signal line Vi3 outputs a LOW signal. Thus, in the spike output unit 20a of the present example, a pulse at a LOW level (negative polarity) is output as the output voltage Vout upon detecting a photon reception reaction.

At this time, a LOW voltage is applied to the gate of the transistor 11 and the gate of the transistor 12. In response to this, a source-drain channel of the transistor 11 including a P-MOS transistor is closed, and a drain-source channel of the transistor 12 including an N-MOS transistor is opened. Therefore, the signal line Vi2 is electrically disconnected from the signal line Vi1, and the voltage is raised to HIGH by the power supply voltage Vdd. Because a HIGH voltage is applied to the gate of the transistor 13, a source-drain channel of the transistor 13 is opened.

When a voltage output from the inverter 15 becomes LOW, the pulse generator 16 outputs a pulse at a HIGH level (positive polarity) to the signal line INI with a predetermined time delay. With this arrangement, a voltage at a HIGH level is applied to the gate of the transistor 14, and a drain-source channel of the transistor 14 is closed. Therefore, the signal line Vi3 is initialized by the ground potential and a voltage of the signal line Vi3 becomes LOW. When the voltage of the signal line Vi3 becomes LOW, the voltage output from the inverter 15 becomes HIGH. Therefore, a LOW-level period of the output voltage Vout ends. That is, one pulse output ends.

By adjusting a time delay from when a LOW-level pulse is input to the pulse generator 16 from the inverter 15 to when the pulse generator 16 generates a HIGH-level pulse, the LOW-level period of the output voltage Vout, that is, a length of a pulse indicating a photon reception reaction can be changed.

When the voltage output from the inverter 15 becomes HIGH, a HIGH voltage is applied to the gate of the transistor 11 and the gate of the transistor 12. Therefore, the source-drain channel of the transistor 11 is opened, and a drain-source channel of the transistor 12 is closed. Because a channel between the signal lines Vi1 and Vi2 becomes conductive, it is possible to detect a photon reception reaction again.

As understood from the above description of operation, in the spike output unit 20a, voltage in the circuit is reset each time a pulse is output in response to a photon reception reaction. Therefore, even in a case where high illuminance light is incident on the SPAD element 21, that is, even in a case where the number of times of photon reception reactions per unit time increases, the detection unit 23 can appropriately detect each photon reception reaction.

With the spike output unit 20a configured as described above, the higher illuminance (in other words, intensity) of the light incident on the SPAD element 21, the narrower an interval of the pulses output by the detection unit 23 That is, the spike output unit 20a is configured to be able to output a signal with a characteristic similar to a characteristic of the spike train illustrated in FIG. 3.

(1-4. Configurations of Calculation Unit, Count Unit, and Output Unit)

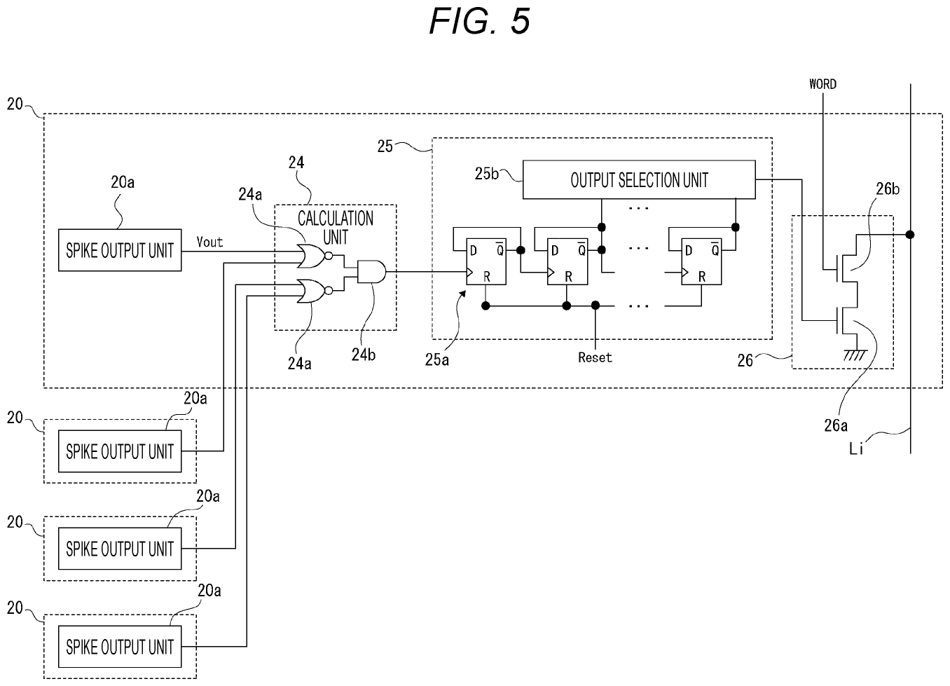

FIG. 5 is a diagram for describing an internal configuration example of the calculation unit 24, the count unit 25, and the output unit 26.

The calculation unit 24 includes a logic circuit for causing the count unit 25 to execute count of pulses on condition that the spike output unit 20a (detection unit 23) in the own pixel and the spike output units 20a (detection units 23) in the predetermined number of other pixels including at least the another pixel adjacent to the own pixel detect photon reception reactions.

As an illustrative example, FIG. 5 illustrates a case where the above-described predetermined number of other pixels is three, and the calculation unit 24 is provided with two NOR gate circuits 24a and one AND gate circuit 24b as logic circuits for obtaining AND of pulses output by the spike output units 20a of the four pixels 20 in total including the three other pixels and the own pixel. In this case, outputs from the spike output units 20a of the own pixel and any one of the other pixels are input to one NOR gate circuit 24a, and outputs from the spike output units 20a of the remaining two other pixels are input to another NOR gate circuit 24a. Then, outputs from the respective NOR gate circuits 24a are input to the AND gate circuit 24b.

In the calculation unit 24 configured as described above, output of the AND gate circuit 24b becomes HIGH in a case where photon reception reactions are detected almost simultaneously in the own pixel and all of the above-described predetermined number of other pixels, and the above-described LOW-level pulses are input to respective input terminals of the two NOR gate circuits 24a.

The count unit 25 includes a digital counter 25a and an output selection unit 25b. In the present example, the digital counter 25a has a configuration in which at least three or more D flip-flops are connected in columns. Specifically, each of the D flip-flops except for a D flip-flop at a last stage has a D terminal and a Q-bar terminal connected to each other, and a connection point pf the D terminal and Q-bar terminal is connected to a clock terminal of a D flip-flop at a next stage. The output of the AND gate circuit 24b in the calculation unit 24 is input to a clock terminal of a D flip-flop at a foremost stage.

With this arrangement, the digital counter 25a can count the number of times the output of the AND gate circuit 24b becomes HIGH. That is, it is possible to count the number of times that, not only the own pixel, but also the above-described predetermined number of other pixels detect the photon reception reactions simultaneously. In other words, the number of times of photon reception reactions of the own pixel is counted on condition that, not only the own pixel, but also the above-described predetermined number of times of other pixels detect the photon reception reactions simultaneously.

A count value from the digital counter 25a can be reset by a reset signal (Reset in the drawing) from outside.

Note that a configuration of the digital counter 25a is not limited to the configuration exemplified above, and another known configuration can be adopted.

The output selection unit 25b determines whether or not the count value from the digital counter 25a is equal to or greater than a predetermined value, and, in a case where it is determined that the count value is greater than or equal to the predetermined value, outputs, to the output unit 26, a signal indicating that the count value is greater than or equal to the predetermined value.

Outputs of the respective D flip-flops of a second and subsequent stages in the digital counter 25a are input to the output selection unit 25b. In the output selection unit 25b, it is determined which stage of the D flip-flop is to be used as a criterion, and a signal is output to the output unit 26 in response to output of the D flip-flop of the stage used as the criterion being HIGH. In other words, when the count value is equal to or more than a predetermined threshold value (a natural number of 2 or more), a signal indicating that the count value is equal to or more than the predetermined threshold value is output to the output unit 26.

The output unit 26 outputs the output signal from the output selection unit 25b to a vertical signal line Li in response to reception of a word signal via the row control line WORD. Specifically, the output unit 26 of the present example includes a transistor 26a including an N-MOS transistor of which gate is to be supplied with an output signal from the output selection unit 25b, and a transistor 26b including an N-MOS transistor of which gate is connected to the row control line WORD, and series-connection circuits of the transistor 26a and transistor 26b are inserted between the vertical signal line Li and a ground potential.

By the word signal being input to the gate of the transistor 26b via the row control line WORD, an output signal from the output selection unit 25b is output to the vertical signal line Li via the transistors 26a and 26b.

With this arrangement, when the count value of the digital counter 25a becomes equal to or greater than the predetermined threshold value within one frame period, a signal indicating that the count value of the digital counter 25a is equal to or greater than the predetermined threshold value within one frame period is read as an output signal of the pixel 20 via the vertical signal line Li.

Note that it is conceivable that a timing to reset the count value in the digital counter 25a is a timing at which the output value of the own pixel is read according to supply of the above-described word signal. Alternatively, it is also conceivable that the timing to reset the count value in the digital counter 25a is a timing at which an output by the output selection unit 25b becomes HIGH (that is, a timing at which the count value becomes equal to or greater than the predetermined threshold value).

Here, in the above-described example, the output selection unit 25b is provided, and a signal indicating that the count value of the digital counter 25a is equal to or greater than the predetermined threshold value is set as an output signal of the pixel 20. However, it is also possible to adopt a configuration in which a signal indicating a count value of the digital counter 25a is set as an output signal of the pixel 20, without providing the output selection unit 25b.

### 2. Second Embodiment

Next, a second embodiment will be described. In the second embodiment, an analog counter is used for counting pulses indicating that a photon reception reaction is detected.

Note that, in the following description, parts similar to parts already described will be denoted by the same reference signs, and the description thereof will be omitted.

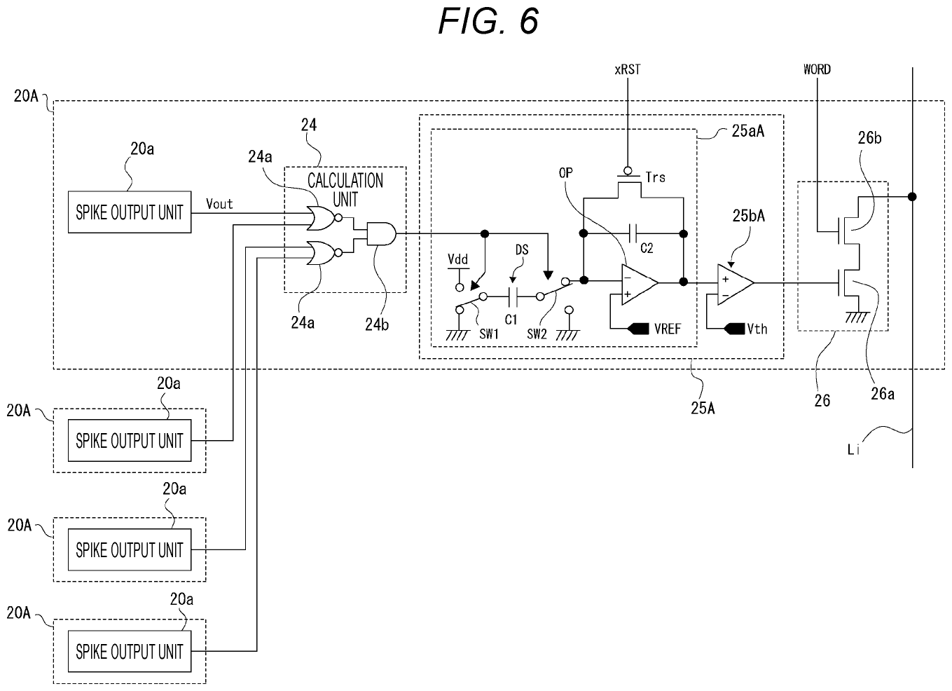

FIG. 6 is a diagram for describing a configuration of a pixel 20A as a first example of the second embodiment.

The pixel 20A is different from the pixel 20 in that a count unit 25A is provided instead of the count unit 25. The count unit 25A is different in that an analog counter 25aA is provided instead of the digital counter 25a, and a comparator 25bA is provided instead of the output selection unit 25b.

The analog counter 25aA includes a discharge unit DS including a first capacitor C1, a first switch SW1, and a second switch SW2, a reset transistor Trs, a second capacitor C2, and an operational amplifier OP.

In the discharge unit DS, the first switch SW1 is configured to be switchable between a state in which one end of the first capacitor C1 is connected to a power supply voltage Vdd and a state in which the one end is grounded. The second switch SW2 is configured to be switchable between a state in which an another end of the first capacitor C1 is grounded and a state in which the another end of the first capacitor C1 is connected to one end of the second capacitor C2.

An output signal from the calculation unit 24 is supplied as a switching control signal to the first switch SW1 and the second switch SW2. Specifically, the first switch SW1 operates so that the one end of the first capacitor C1 is connected to the power supply voltage Vdd if the output signal from the calculation unit 24 is HIGH, and that the one end of the first capacitor C1 is grounded if the output signal is LOW. Furthermore, the second switch SW2 operates so that the another end of the first capacitor C1 is grounded if the output signal from the calculation unit 24 is HIGH, and the another end of the first capacitor C1 is connected to the one end of the second capacitor C2 if the output signal is LOW.

One end of the second capacitor C2 is connected to an inverting input terminal of the operational amplifier OP, and another end of the second capacitor C2 is connected to an output terminal of the operational amplifier OP. A reference voltage VREF is input to a non-inverting input terminal of the operational amplifier OP.

A P-MOS transistor is used as a reset transistor Trs in the present example, and is connected in parallel to the second capacitor C2. A gate of the reset transistor Trs is connected to a supply line of a reset signal xRST. The reset signal xRST is, for example, a signal that is turned on/off in units of rows like the above-described word signal. Alternatively, the reset signal xRST may be a signal that is globally controlled at the same time for all pixels.

In the analog counter 25aA configured as described above, an output voltage indicating a count result is obtained at a connection point between the another end of the second capacitor C2 and the output terminal of the operational amplifier OP.

In the analog counter 25aA, when the reset signal xRST is turned on, the second capacitor C2 is fully charged by a reset operation by the reset transistor Trs. Thereafter, when an output of the calculation unit 24 becomes HIGH, the first capacitor C1 is charged with a charge corresponding to the power supply voltage Vdd by operations by the first switch SW1 and second switch SW2 described above. That is, the first capacitor C1 is charged with a charge corresponding to one output pulse from the calculation unit 24. Then, when the output of the calculation unit 24 changes from HIGH to LOW, the one end of the first capacitor C1 is grounded and the another end of the first capacitor C1 is connected to the one end of the second capacitor C2.

With the above-described operation, in response to a pulse output from the calculation unit 24, the first capacitor C1 is charged with a charge corresponding to one output pulse, and then a charge corresponding to the charge in the first capacitor C1 is extracted from the second capacitor C2.

As a result, a charge charged in the second capacitor C2 is discharged by an amount according to the number of times of pulse outputs from the calculation unit 24. That is, a voltage between the terminals of the second capacitor C2 indicates the number of times of pulse generations.

The voltage output from the analog counter 25aA is input to a non-inverting input terminal of the comparator 25bA, a predetermined threshold voltage Vth is input to an inverting input terminal of the comparator 25bA, and a voltage output from the comparator 25bA becomes HIGH in response to the voltage output from the analog counter 25aA becoming equal to or higher than the threshold voltage Vth. With this arrangement, similarly to the output selection unit 25b described above, in response to the number of times of pulse generations being equal to or greater than the predetermined threshold value, the comparator 25bA operates to output a signal indicating that the number of times of pulse generations is equal to or greater than the predetermined threshold value.

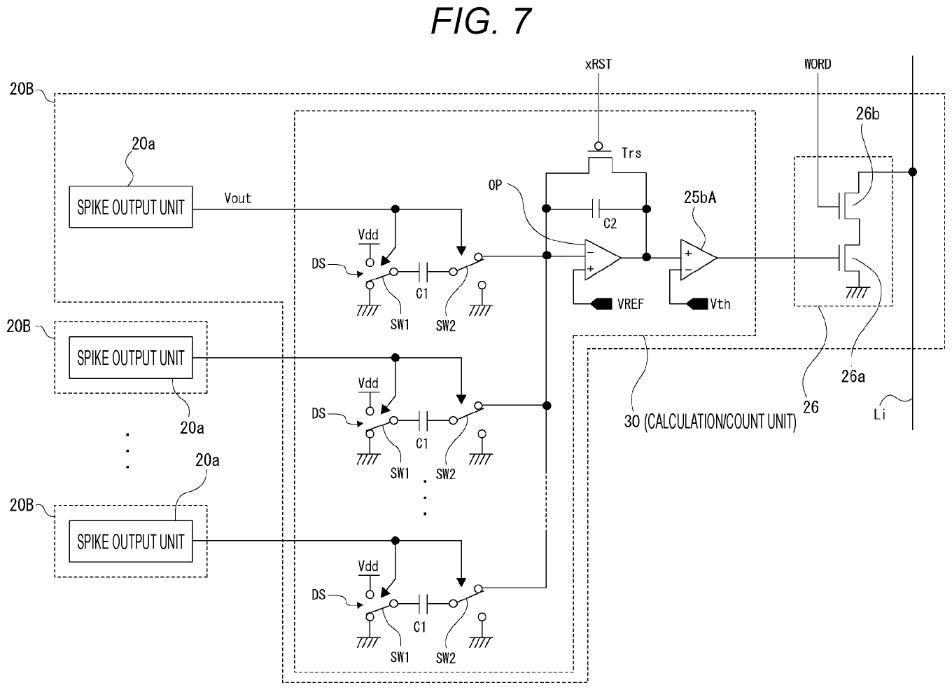

FIG. 7 is a diagram for describing a configuration of a pixel 20B as a second example of the second embodiment. The second example uses an analog counter for counting the number of pulses similarly to the first example, but is different in that count values of pulses output by spike output units 20a in a respective predetermined number of other pixels including at least an another pixel adjacent to an own pixel is reflected to a count value of pulses output by a spike output unit 20a in the own pixel.

The pixel 20B is different from the pixel 20A in that a calculation/count unit 30 is provided instead of the omitted calculation unit 24 and count unit 25A.

Similarly to the count unit 25A, the calculation/count unit 30 includes a second capacitor C2, an operational amplifier OP, a second capacitor C2, and a comparator 25bA, and also includes a plurality of discharge units DS.

In the calculation/count unit 30, when the above-described predetermined number is n (n is a natural number of 2 or more), n+1 discharge units DS are provided in total including one discharge unit for the own pixel. To each of the discharge units DS, an output voltage Vout of a spike output unit 20a in one corresponding pixel 20B is input as a switching control signal for a first switch SW1 and a second switch SW2.

In this case, the first switch SW1 and second switch SW2 of each of the discharge units DS operate as follows with respect to a change in HIGH/LOW of a corresponding output voltage Vout. That is, each first switch SW1 operates so that one end of the first capacitor C1 is connected to a power supply voltage Vdd if the corresponding output voltage Vout is LOW (that is, if a photon reception reaction is detected), and that the one end of the first capacitor C1 is grounded if the output voltage Vout is HIGH. Furthermore, each second switch SW2 operates so that an another end of the first capacitor C1 is grounded if a corresponding output voltage Vout is LOW, and that the another end of the first capacitor C1 is connected to a one end of the second capacitor C2 if the output voltage Vout is HIGH.

With the above-described configuration, a charge charged in the second capacitor C2 in this case is discharged by a discharge unit DS of each of pixels 20B in which a photon reception reaction is detected. That is, in the calculation/count unit 30, the count value of the pulses output by the spike output unit 20a in each of an n-number of other pixels is reflected to the count value of the pulses output by the spike output unit 20a in the own pixel.

By reflecting the pulse count values of the predetermined number of other pixels in vicinity including the another pixel adjacent to the pulse count value of the own pixel in this manner, it is possible to reproduce a role of a horizontal cell in a human eye.

Note that, although the comparator 25bA is provided in a subsequent stage of the analog counter in the above-described example, it is also possible to output a signal indicating a count value from the analog counter to the output unit 26 without providing the comparator 25bA.

### 3. Third Embodiment

In a third embodiment, an output value of a pixel is read by an arbiter method.

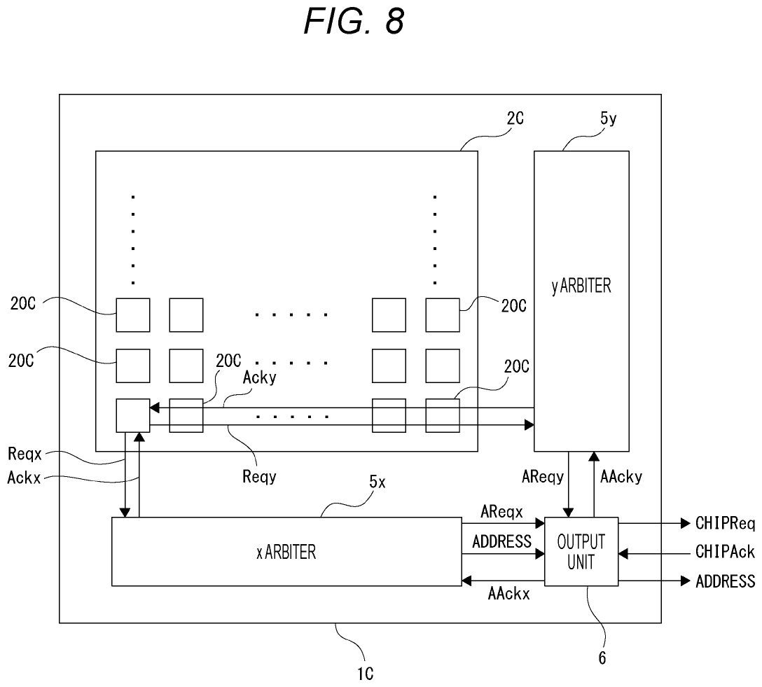

FIG. 8 is a block diagram illustrating an internal configuration example of a sensor device 1C as the third embodiment.

As illustrated in the drawing, the sensor device 1C includes a pixel array unit 2C, an x arbiter 5x and y arbiter 5y that constitute an arbiter, and an output unit 6. The pixel array unit 2C is different from the pixel array unit 2 in including pixels 20C instead of the pixels 20. Each pixel 20C is configured to be able to output a request Reqx in an x direction (row direction) as a read request to the x arbiter 5x and to be able to receive an acknowledgment Ackx as an acknowledgment from the x arbiter 5x. Furthermore, each pixel 20C is configured to be able to output a request Reqy in a y direction (column direction) as a read request to the y arbiter 5y and to be able to receive an acknowledgment Acky in the y direction as an acknowledgment from the y arbiter 5y.

At least either the x arbiter 5x or the y arbiter 5y is provided with an address decoder for generating address information (ADDRESS) for identifying a pixel 20C that has made a read request. In the drawing, a case where the x arbiter 5x has an address decoder is exemplified, but an address decoder may be provided in the y arbiter 5y.

The output unit 6 can receive a request AReqx, which is a request made by the x arbiter 5x in response to a request Reqx from a pixel 20C, and a request AReqy made by the y arbiter 5y in response to a request Reqy from the pixel 20C, and can transmit an acknowledgment AAckx to the x arbiter 5x and an acknowledgment AAcky to the y arbiter 5y.

The output unit 6 exchanges the above-described request AReqx and acknowledgment AAckx with the x arbiter 5x, exchanges the above-described request AReqy and acknowledgment AAcky with the y arbiter 5y, and outputs, to an external device (external chip) of the sensor device 1C, the address information (ADDRESS) of the pixel 20C that has made a read request. In outputting the address information, the output unit 6 transmits a request CHIPReq to the above-described external device and receives an acknowledgment CHIPAck from the above-described external device.

Note that, in a case of the present example, specific processing performed by the above-described x arbiter 5x, the y arbiter 5y, and the output unit 6 is similar to processing described in Reference Document 1 below.

However, the specific processing performed by the x arbiter 5x, the y arbiter 5y, and the output unit 6 is not limited to the processing described in Reference Document 1, and is only required to be any processing as long as the processing is for arbitrating at least a read request from a pixel 20C and for outputting address information of the pixel 20C that has made the read request.

Note that, in the arbiter method, it is also possible to adopt a configuration that handles not only address information of a pixel 20C that has made a read request but also a time stamp indicating a time at which the request is made (in other words, an event occurrence time).
Reference Document 1: Event-Based Neuromorphic Systems, Shih-Chi Liu et, al., ISBN-13: 978-0470018491

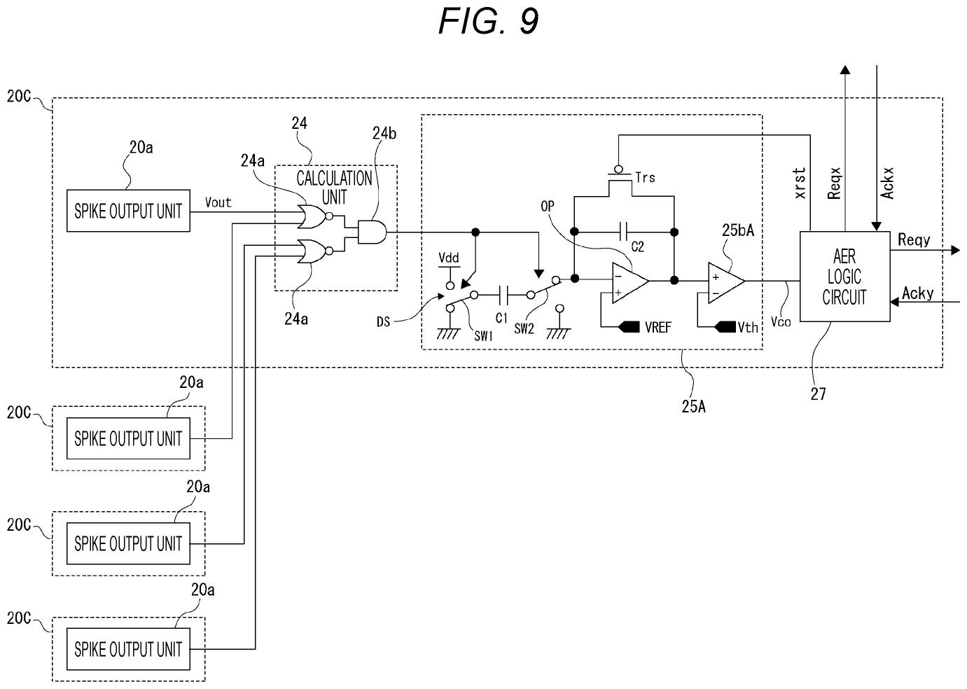

FIG. 9 is a diagram for describing a configuration of the pixel 20C.

The pixel 20C is different from the pixel 20A illustrated in FIG. 6 in that an address event representation (AER) logic circuit 27 is provided instead of the output unit 26.

The AER logic circuit 27 inputs an output signal from a comparator 25bA in a count unit 25A, and outputs a request Reqx and a request Reqy to an x arbiter 5x and a y arbiter 5y, respectively, in response to the output signal becoming HIGH. In other words, a signal, which indicates that the number of times of photon reception reactions being detected in an own pixel and a predetermined number of other pixels has become equal to or greater than a predetermined threshold value, is input as an event signal, and a request is made to the x arbiter 5x and the y arbiter 5y in response to the input of the event signal.

Furthermore, the AER logic circuit 27 outputs a reset signal xrst to a gate of a reset transistor Trs of the count unit 25A in response to reception of acknowledgments Ackx and Acky from the x arbiter 5x and the y arbiter 5y in response to the requests Reqx and Reqy. With this arrangement, in the count unit 25A in this case, a count value of an analog counter 25aA is reset each time an event is read, and a new event is detectable.

Here, in FIG. 9, the output signal (output voltage) from the comparator 25bA is denoted as “Vco”.

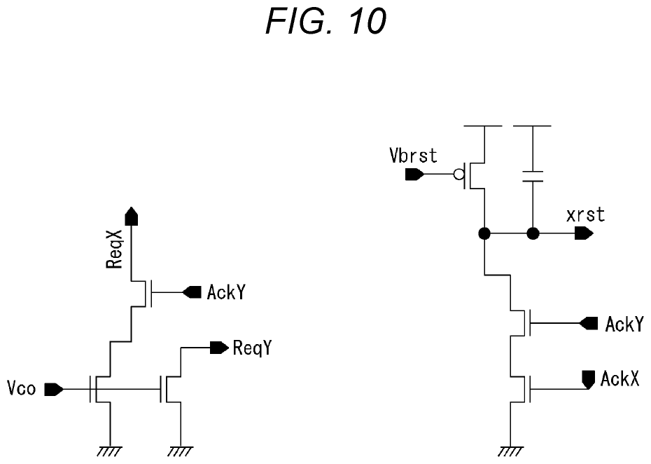

FIG. 10 is a diagram illustrating an internal configuration example of the AER logic circuit 27.

As illustrated in the drawing, in the present example, a configuration of a general AER logic is adopted as the AER logic circuit 27. In the present example, with a configuration illustrated on a left side of FIG. 10, a request Reqy to the y arbiter 5y is output in response to occurrence of an event (an output voltage Vco is HIGH), and thereafter, a request Reqx to the x arbiter 5x is made in response to an acknowledgment Acky from the y arbiter 5y. Furthermore, with a configuration on a right side of FIG. 10, a reset signal xrst is output in response to reception of an acknowledgment Acky from the y arbiter 5y and an acknowledgment Ackx from the x arbiter 5x.

Note that, although FIG. 9 illustrates a configuration example corresponding to a case of using the count unit 25A, the arbiter method can also be applied to a case of using the calculation/count unit 30 (FIG. 7) or a case of using the count unit 25 including the digital counter 25a (FIG. 5). For example, in a case where the calculation/count unit 30 is used, it is only required to provide the AER logic circuit 27 instead of the output unit 26, so that the reset signal xrst from the AER logic circuit 27 is output to the gate of the reset transistor Trs. Furthermore, in a case where the count unit 25 is used, the AER logic circuit 27 is provided instead of the output unit 26. The AER logic circuit 27 in this case is configured to output the requests Reqx and Reqy to the x arbiter 5x and the y arbiter 5y, respectively, in response to an output signal from an output selection unit 25b in the count unit 25 becoming HIGH.

### 4. Modification Examples

Here, the embodiments are not limited to the specific examples exemplified above, and may be configured as various modifications.

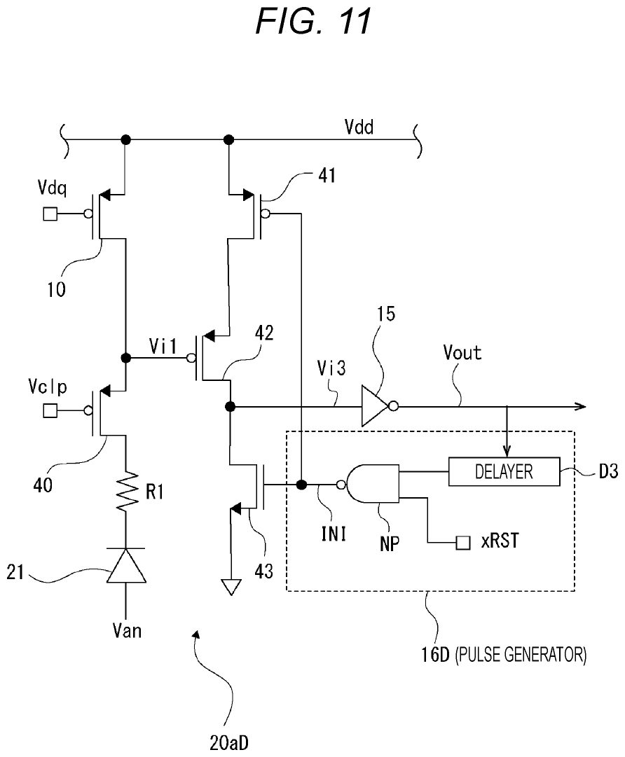

For example, the spike output unit 20a can be replaced with a spike output unit 20aD as exemplified in FIG. 11. The spike output unit 20aD has a smaller number of transistors than the spike output unit 20a does.

The spike output unit 20aD includes a SPAD element 21, a resistor R1, a transistor 10, a transistor 40, a transistor 41, a transistor 42, a transistor 43, an inverter 15, and a pulse generator 16D. The pulse generator 16D includes a delayer D3 and a NAND gate circuit NP as internal components. The transistor 10, the transistor 40, the transistor 41, and the transistor 42 are P-MOS transistors. Meanwhile, the transistor 43 is an N-MOS transistor.

The transistor 10 corresponds to a load element of the SPAD element 21 as in the case of the spike output unit 20a.

Sources of the transistor 10 and transistor 41 are connected to a power supply voltage Vdd. A drain of the transistor 10 is connected to a gate of the transistor 42 via a signal line Vi1. Furthermore, the drain of the transistor 10 is also connected to a source of the transistor 40. The resistor R1 is connected between a drain of the transistor 40 and a cathode of the SPAD element 21. A voltage Van is applied to an anode of the SPAD element 21.

A source of the transistor 42 is connected to a drain of the transistor 41. Meanwhile, a drain of the transistor 42 is connected to the inverter 15 via a signal line Vi3. Furthermore, the drain of the transistor 42 is also connected to a drain of the transistor 43. A source of the transistor 43 is connected to a ground potential. A gate of the transistor 43 is connected to an output terminal of the NAND gate circuit NP and a gate of the transistor 41. An output terminal of the inverter 15 is connected to an output line of an output voltage Vout. The delayer D3 is connected between the output line of the output voltage Vout and one input terminal of the NAND gate circuit NP. Another input terminal of the NAND gate circuit NP is connected to a terminal xRST.

Operation of the spike output unit 20aD according to the above-described configuration will be described.

When the SPAD element 21 reacts with photons, current between a cathode and anode thereof increases, and voltage of the signal line Vi1 becomes LOW due to a voltage drop between a source and drain of the transistor 10. Therefore, a LOW voltage is applied to the gate of the transistor 42, and a source-drain channel of the transistor 42 is closed. Accordingly, current flowing between the source and drain of the transistor 41 increases. Therefore, gate-source voltage of the transistor 41 increases due to an Id-Vgs characteristic.

That is, substantially at the same time as a source-drain channel of the transistor 42 is closed, a gate-source channel of the transistor 41 is also closed. Because both the transistor 41 and the transistor 42 are turned on, voltage of the signal line Vi3 is raised to HIGH by the power supply voltage Vdd. When a HIGH voltage is input, the inverter 15 outputs a LOW voltage as the output voltage Vout. Thus, in the spike output unit 20aD, a pulse at a LOW level (negative polarity) is output as the output voltage Vout upon detecting a photon reception reaction. Note that a polarity of a pulse output upon detecting a photon reception reaction is not particularly limited.

When the output voltage Vout becomes LOW, voltage of the one input terminal of the NAND gate circuit NP also becomes LOW later. Therefore, the NAND gate circuit NP outputs a HIGH voltage to a signal line INI. A HIGH voltage is applied to the gate of the transistor 43, and a drain-source channel of the transistor 43 is closed. Furthermore, a drain-source channel of the transistor 41 is opened, and flow-through current from a power supply to a ground. Therefore, a voltage of the signal line Vi3 is initialized by a ground potential and becomes LOW. When the voltage of the signal line Vi3 becomes LOW, the inverter 15 outputs a HIGH voltage as the output voltage Vout. Therefore, the spike output unit 20aD ends output of LOW-level pulses.

Note that, in the spike output unit 20aD, at least either the transistor 40 or the resistor R1 can be omitted.

Here, in the above description, in a case where a value based on a detection result of a photon reception reaction in an own pixel and detection results of photon reception reactions in a predetermined number of other pixels including at least another pixel adjacent to the own pixel is obtained as an output value of the own pixel, it is assumed that the above-described predetermined number of other pixels is fixed. However, the predetermined number of other pixels may be variable. For example, the above-described predetermined number of other pixels can be selected by a kernel Kn.

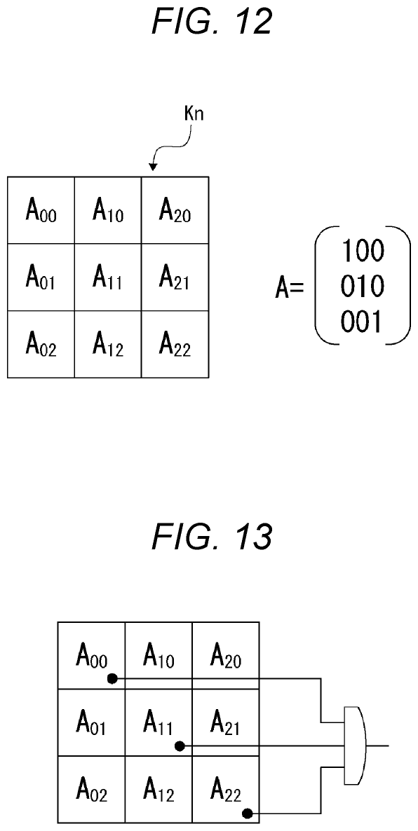

For example, a kernel Kn of 3×3=9 pixels as illustrated on a left side of FIG. 12 is assumed as the kernel Kn. Here, for the kernel Kn, a position of each of the pixels is defined by (i, j) coordinates. For example, it is assumed that a value of i of a pixel column positioned on a leftmost side is “0”, and the value of i increases rightward. Furthermore, for a value of j, it is assumed that the value of j of a pixel row positioned on an uppermost side is “0”, and the value of j increases rightward.

For example, it is assumed that coefficients as illustrated on a right side of the drawing are set for respective pixel positions for this kernel Kn. In the kernel Kn, a pixel to be processed is a pixel of (i, j)=(1,1) positioned at a center. According to a setting of the coefficients exemplified in FIG. 12, it means that an output value of the pixel to be processed is obtained by using a photon reception reaction detection result of the pixel to be processed and photon reception reaction detection results of pixels adjacent to an upper left and lower right of the pixel to be processed. In this case, a coefficient=0 means that a photon reception reaction detection result of the pixel at a corresponding position is not used.

As illustrated in FIG. 13, assuming that a logical AND (AND) of the corresponding pixels is obtained according to the coefficients of the kernel Kn exemplified in FIG. 12, an output of a target pixel is obtained only in a case where reactions (ignition, occurrence of event) occur in the corresponding pixels at substantially the same time in terms of time.

Note that the setting of the kernel Kn as described above is desirably implemented in a programmable manner instead of a hard-wired manner. For example, the setting can be easily implemented by providing an enable circuit that switches validity/invalidity of a detection result of each pixel.

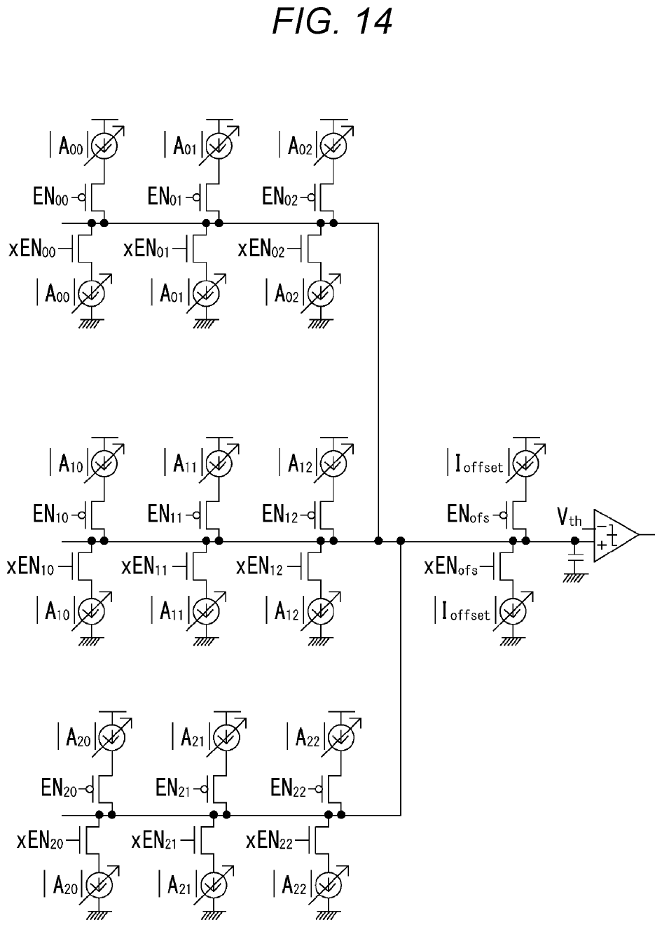

Furthermore, another implementation method may be an analog method. The analog method will be described with reference to FIG. 14.

As illustrated in FIG. 14, in a case of the analog method, there are provided N-MOS and P-MOS transistors that receive outputs of the respective pixels from (i, j)=(0, 0) to (i, j)=(2, 2) and connect current sources to a common node, a capacitor that accumulates current and the current sources determined by an absolute value of the current, and the current sources and comparator that define an offset as an initial voltage (charge) or leak current. A coefficient of the kernel Kn is defined by an absolute value of a current source. If the coefficient of the kernel Kn is positive, the transistor on a P-MOS side is turned on, and current from the current source (|Aij|) flows to a common node.

If the coefficient of the kernel Kn is zero, neither the P-MOS transistor nor the N-MOS transistor is turned on, and current is zero. In a case where the coefficient of the kernel Kn is negative, the transistor on an N-MOS side is turned on, and the current is extracted with a certain coefficient (|Aij|) from the common node. A final current value is compared with a predetermined threshold voltage Vth, and the target pixel is output depending on whether or not the threshold value is exceeded.

Note that a configuration of the analog counter is not limited to the configurations exemplified in FIGS. 6 and 7.

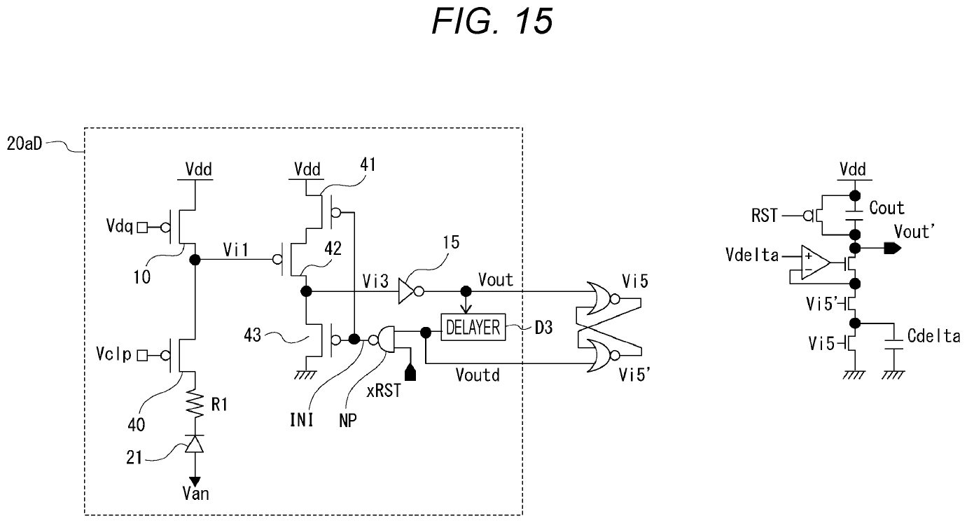

FIG. 15 is an explanatory diagram of another example of the analog counter.

Here, there is exemplified a case where the spike output unit 20aD is used as a configuration for outputting a spike train, but another configuration such as a spike output unit 20a may be used.

There are provided a first NOR gate circuit to which an output voltage Vout from an inverter 15 is input and a second NOR gate circuit to which a delayed output voltage Voutd obtained by delaying the output voltage Vout with the delayer D3 is input, an output from the first NOR gate circuit is input to the second NOR gate circuit as illustrated in the drawing, and an output from the second NOR gate circuit is input to the first NOR gate circuit.

When the spike output unit 20aD outputs a pulse, a pulse is generated in an output voltage Vi5 of the first NOR gate circuit, and the charge in a capacitor Cdelta at a subsequent stage is discharged. After the generation of the pulse, is connected to an output of an operational amplifier to which a transistor to be controlled by an output voltage Vi5′ of the second NOR gate circuit is connected, and the capacitor Cdelta is charged with a voltage Vdelta. By repeating this operation, an analog voltage varies depending on how many times charge in a capacitor Cout initialized by an RST in the drawing is extracted, and, for example, an output voltage Vout′ is controlled by a voltage “Vdd-N*Cdelta*Vdelta” by extraction operations of N times.

Note that, in addition to the configuration exemplified in FIG. 15, there may be conceivable a mechanism for controlling validity/invalidity of a calculation, changing a rate of capacitance, or the like. An analog calculation in the subsequent stage may be performed by using the configuration in FIG. 7 or the like, or may be performed after an analog signal is once output to outside and converted by an A/D converter.

### 5. Summary of Embodiments

As described above, the sensor devices (sensor device 1, 1C) according to the embodiments include an SPAD element (SPAD element 21), a detection unit (detection unit 23) that detects a photon reception reaction by the SPAD element to output a pulse indicating the photon reception reaction, and, in response to the pulse output, resets a state of own to a state in which a photon reception reaction is detectable, and a pulse count unit (count unit 25, 25A, calculation/count unit 30) that counts the number of the pulses output by the detection unit.

With a configuration in which the detection unit performs the above-described reset, a spike train can be appropriately obtained even in a high illuminance state, and the number of spikes (the number of pulses) in the spike train can be appropriately counted by the above-described pulse count unit.

Therefore, it is possible to implement a spike camera imitating a photosensitive characteristic of human eyes.

Furthermore, in the sensor devices according to the embodiments, a plurality of pixels including the SPAD element, the detection unit, and the pulse count unit are two-dimensionally arranged.

This makes it possible to implement a spike camera capable of acquiring a two-dimensional captured image.

Moreover, in the sensor devices according to the embodiments, the pixel includes a calculation unit (calculation unit 24, calculation/count unit 30) (refer to FIGS. 5, 6, 7, and 14) that performs calculation for obtaining an output value of an own pixel on the basis of a detection result, from the detection unit, of the photon reception reaction in the own pixel and detection results, from the detection unit, of photon reception reactions in a predetermined number of other pixels including at least another pixel adjacent to the own pixel.

By obtaining the output value of the own pixel in consideration of not only the photon reception reaction of the own pixel but also at least the photon reception reaction of the adjacent another pixel, it is possible to reproduce a role of a horizontal cell in a human eye.

Therefore, it is possible to achieve improved reproducibility of a photosensitive characteristics of human eyes.

Further, in the sensor devices according to the embodiments, the calculation unit (calculation unit 24) cause the pulse count unit to execute count of the pulses on condition that the detection unit in the own pixel and the detection units in the predetermined number of other pixels detect the photon reception reaction (refer to FIGS. 5, 6, and the like).

As described above, by executing a pulse counting of the own pixel on condition that not only the own pixel but also the predetermined number of other pixels in vicinity including the another pixel adjacent to the own pixel detect photon reception reactions, it is possible to reproduce a role of a horizontal cell in a human eye.

Therefore, it is possible to achieve improved reproducibility of a photosensitive characteristics of human eyes.

Furthermore, in the sensor devices according to the embodiments, the calculation unit determines, by using an AND gate circuit, whether or not the condition is satisfied.

This makes it possible to appropriately perform the condition determination by using a digital logic circuit.

Moreover, in the sensor devices according to the embodiments, the calculation unit (calculation/count unit 30) reflects a count value of the pulses output by the detection unit in each of the predetermined number of other pixels to the count value of the pulses output by the detection unit in an own pixel (refer to FIGS. 7, 14, and the like).

As described above, by reflecting the pulse count values of the predetermined number of other pixels in vicinity including the another pixel adjacent to the pulse count value of the own pixel in this manner, it is possible to reproduce a role of a horizontal cell in a human eye.

Therefore, it is possible to achieve improved reproducibility of a photosensitive characteristics of human eyes.

Further, in the sensor devices according to the embodiments, the predetermined number of other pixels are selected by a kernel (refer to FIGS. 12 to 14).

This makes it possible to variably set, by using the kernel, which pixels are to be used as the other pixels that affect the output value of the own pixel.

Furthermore, in the sensor devices according to the embodiments, the pulse count unit (count unit 25, 25A, and calculation/count unit 30) outputs a signal in a case where the number of counts of the pulses is equal to or greater than a threshold value (refer to FIGS. 5, 6, 7, 14, 15, and the like).

This makes it possible to output a value indicating whether or not a luminance is equal to or more than a certain level as the output value of the pixel.

Moreover, in the sensor devices according to the embodiments, the pulse count unit counts the number of the pulses with a digital counter.

This makes it possible to appropriately perform the pulse count by using a digital logic circuit.

Further, in the sensor devices according to the embodiments, the pulse count unit counts the number of the pulses with an analog counter.

By using the analog counter, the number of pulses can be counted with a simple configuration.

Furthermore, in the sensor devices according to the embodiments, the analog counter includes a counter using a capacitor (second capacitor C2) in which a charged amount changes according to the pulse output by the detection unit.

By using a counter using the capacitor as described above, pulse count can be achieved with a simple configuration.

Moreover, the sensor device according to an embodiment (sensor device 1) includes a row control circuit (row control circuit 3) that executes reading of output values of the pixels for each pixel row.

With this arrangement, the output values of the pixels are read by a scanning method.

Because an existing circuit configuration for reading a pixel value with a scanning method can be used, costs for the sensor device can be reduced.

Further, the sensor device according to an embodiment (sensor device 1C) reads output values of the pixels with an arbiter method.

By adopting the arbiter method, it is possible to quickly read the values of the pixels having undergone a photon reception reaction according to a predetermined mode.

Note that the effects described in the present specification are merely examples and are not limited, and other effects may be provided.

### 6. Present Technology

Note that the present technology can also employ the following configurations.
(1)
A sensor device including
an SPAD element,
a detection unit that detects a photon reception reaction by the SPAD element to output a pulse indicating the photon reception reaction, and, in response to the pulse output, resets a state of own to a state in which a photon reception reaction is detectable, and
a pulse count unit that counts the number of the pulses output by the detection unit.
(2)
The sensor device according to (1),
in which a plurality of pixels including the SPAD element, the detection unit, and the pulse count unit is two-dimensionally arranged.
(3)
The sensor device according to (2),
in which the pixel includes a calculation unit that performs calculation for obtaining an output value of an own pixel on the basis of a detection result of the photon reception reaction, by the detection unit in the own pixel, and detection results of photon reception reactions, by the detection units in a predetermined number of other pixels including at least another pixel adjacent to the own pixel.
(4)
The sensor device according to (3),
in which the calculation unit cause the pulse count unit to execute count of the pulses on condition that the detection unit in the own pixel and the detection units in the predetermined number of other pixels detect the photon reception reactions.
(5)
The sensor device according to (4),
in which the calculation unit determines, by using an AND gate circuit, whether or not the condition is satisfied.
(6)
The sensor device according to (3),
in which the calculation unit reflects a count value of the pulses output by the detection unit in each of the predetermined number of other pixels to the count value of the pulses output by the detection unit in an own pixel.
(7)
The sensor device according to any one of (3) to (6),
in which the predetermined number of other pixels are selected by a kernel.
(8)
The sensor device according to any one of (1) to (7),
in which the pulse count unit outputs a signal in a case where the number of counts of the pulses is equal to or greater than a threshold value.
(9)
The sensor device according to any one of (1) to (8),
in which the pulse count unit counts the number of the pulses with a digital counter.
(10)
The sensor device according to claim 1,
in which the pulse count unit counts the number of the pulses with an analog counter.
(11)
The sensor device according to (10),
in which the analog counter includes a counter using a capacitor in which a charged amount changes according to the pulse output by the detection unit.
(12)
The sensor device according to any one of (2) to (11), the sensor device further including a row control circuit that executes reading of output values of the pixels for each pixel row.
(13)
The sensor device according to any one of (2) to (11), the sensor device reading output values of the pixels with an arbiter method.

### REFERENCE SIGNS LIST

1, 1C Sensor device
2, 2C Pixel array unit
3 Row control circuit
4 Signal processing/output circuit
5x x arbiter
5y y arbiter
6 Output unit
20, 20A, 20B, 20C Pixel
20a, 20aD Spike output unit
21 SPAD element
22 Quenching unit
23 Detection unit
24 Calculation unit
24a NOR gate circuit
24b AND gate circuit
25, 25A Count unit
25a Digital counter
25aA Analog counter
25b Output selection unit
25bA Comparator
26 Output unit
26a, 26b Transistor
27 AER logic circuit
30 Calculation/count unit
C1 First capacitor
SW1 First switch
SW2 Second switch
DS Discharge unit
C2 Second capacitor
OP Operational amplifier
Kn Kernel

1. A sensor device comprising:
an SPAD element;
a detection unit that detects a photon reception reaction by the SPAD element to output a pulse indicating the photon reception reaction, and, in response to the pulse output, resets a state of own to a state in which a photon reception reaction is detectable; and
a pulse count unit that counts the number of the pulses output by the detection unit.

2. The sensor device according to claim 1,
wherein a plurality of pixels including the SPAD element, the detection unit, and the pulse count unit is two-dimensionally arranged.

3. The sensor device according to claim 2,
wherein the pixel includes a calculation unit that performs calculation for obtaining an output value of an own pixel on a basis of a detection result of the photon reception reaction, by the detection unit in the own pixel, and detection results of photon reception reactions, by the detection units in a predetermined number of other pixels including at least another pixel adjacent to the own pixel.

4. The sensor device according to claim 3,
wherein the calculation unit cause the pulse count unit to execute count of the pulses on condition that the detection unit in the own pixel and the detection units in the predetermined number of other pixels detect the photon reception reactions.

5. The sensor device according to claim 4,
wherein the calculation unit determines, by using an AND gate circuit, whether or not the condition is satisfied.

6. The sensor device according to claim 3,
wherein the calculation unit reflects a count value of the pulses output by the detection unit in each of the predetermined number of other pixels to the count value of the pulses output by the detection unit in an own pixel.

7. The sensor device according to claim 3,
wherein the predetermined number of other pixels are selected by a kernel.

8. The sensor device according to claim 1,
wherein the pulse count unit outputs a signal in a case where the number of counts of the pulses is equal to or greater than a threshold value.

9. The sensor device according to claim 1,
wherein the pulse count unit counts the number of the pulses with a digital counter.

10. The sensor device according to claim 1,
wherein the pulse count unit counts the number of the pulses with an analog counter.

11. The sensor device according to claim 10,
wherein the analog counter includes a counter using a capacitor in which a charged amount changes according to the pulse output by the detection unit.

12. The sensor device according to claim 2, the sensor device further comprising a row control circuit that executes reading of output values of the pixels for each pixel row.

13. The sensor device according to claim 2, the sensor device reading output values of the pixels with an arbiter method.
